(19) United States
(12) Patent Application Publication
(10) Pub. No.: US 2026/0101019 A1
(43) Pub. Date: Apr. 9, 2026

(54) Ingesting Multimedia Data During A Conference

(71) Applicant: Zoom Communications, Inc., San Jose, CA (US)

(72) Inventors: Michael David Harrington, Denver, CO (US); Brendan James Ittelson, San Jose, CA (US); Arun Janakiraman, San Francisco, CA (US); Yi Ke, Santa Clara, CA (US); Shishir Sharma, Ottawa (CA)

(21) Appl. No.: 19/042,576

(22) Filed: Jan. 31, 2025

Related U.S. Application Data
(60) Provisional application No. 63/704,857, filed on Oct. 8, 2024.

(51) Int. Cl. H04N 7/15; H04L 9/40; H04L 12/18

(52) U.S. Cl. CPC H04N 7/155; H04L 12/1822; H04L 63/0807

(57) ABSTRACT

A conferencing server receives, from a client device, a request to connect an ingestion server to a conference to which the client device is connected. The request comprises a token for authentication of the ingestion server and an identifier of the ingestion server. The conferencing server establishes, based on the token, a communication connection with the ingestion server. The conferencing server transmits, to the ingestion server, at least a portion of multimedia data of the conference using the communication connection based on the token.

### CROSS-REFERENCE TO RELATED APPLICATION(S)

This application claims the benefit of U.S. Provisional Ser. No. 63/704,857 , filed on Oct. 8, 2024, titled “INGESTING MULTIMEDIA DATA DURING A CONFERENCE,” the entire disclosure of which is incorporated herein by reference.

### FIELD

This disclosure generally relates to online conferencing, and, more specifically, to ingestion, by an artificial intelligence engine or another data processing engine, of multimedia data during a conference.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 is a block diagram of an example of a system for ingesting multimedia data during a conference.

FIG. 6 is a first data flow diagram of ingesting multimedia data during a conference.

FIG. 7 is a second data flow diagram of ingesting multimedia data during a conference.

FIG. 8 illustrates a first graphical user interface for artificial intelligence-enhanced video conferencing.

FIG. 9 illustrates a second graphical user interface for artificial intelligence-enhanced video conferencing.

FIG. 10 illustrates a third graphical user interface for artificial intelligence-enhanced video conferencing.

FIG. 11 is a flowchart of an example of a technique for ingesting multimedia data during a conference.

### DETAILED DESCRIPTION

Conferencing software is frequently used across various industries to support video-enabled conferences between participants in multiple locations. In some cases, each of the conference participants separately connects to the conferencing software from their own remote locations. In other cases, one or more of the conference participants may be physically located in and connect to the conferencing software from a conference room or similar physical space (e.g., in an office setting) while other conference participants connect to the conferencing software from one or more remote locations. Conferencing software thus enables people to conduct video conferences without requiring them to be physically present with one another. Conferencing software may be available as a standalone software product or it may be integrated within a software platform, such as a unified communications as a service (UCaaS) platform.

In the context of video conferencing, the data generated during conferences, such as audio, camera-generated video, screensharing video, and chat logs, is often merged and lacks structure. This unstructured nature of conference content creates difficulties for developers aiming to electronically process the content, using artificial intelligence (AI), machine learning (ML), or other techniques. Additionally, the lack of granular access to conference data (e.g., speaker identification or participant-specific content), increases the complexity of data processing and escalates the cost of deriving actionable insights, resulting in inefficiencies that impede innovation in AI-driven applications for industries like healthcare, legal, and finance.

To solve problems such as these, some schemes rely on a “participant bot” that joins a conference as a participant and ingests audio, camera-generated video, screensharing, or chat data that the participant bot is permitted to access. However, such a “participant bot” might make the human participants in the conference uncomfortable, as they might not be aware of the identity or the purpose of the “participant bot.” Furthermore, the human participants might have no way to limit the access of the “participant bot”to any data that is shared in the conference.

Implementations of this disclosure address problems such as these by connecting an ingestion server to the conferencing server. The ingestion server includes a communication engine that ingests data of the conference from the conferencing server and a data processing engine (e.g., AI/ML engine) that processes the data of the conference.

At the beginning of a conference, when a client device connects to a conference, the client device provides the conferencing server with a request to connect the ingestion server to the conference. The request includes an identifier of the ingestion server, and a token for authenticating the ingestion server to have access permissions to the conference based on the access permissions of the client device. The conferencing server establishes a communication connection with the ingestion server, using the token to determine the access permissions of the ingestion server to the conference. (For example, if the user of the client device is not permitted to access a transcript or captions, the ingestion server, similarly, is not permitted to access the transcript or captions. If the user leaves the conference, the ingestion server may also be disconnected from the conference.) The conferencing server transmits, to the ingestion server, at least a portion of multimedia data of the conference using the communication connection based on the token. This allows the ingestion server to process the transmitted portion of the multimedia data in AI/ML applications, or to otherwise analyze, store, or forward the multimedia data.

As used herein, the term “token” may include, among other things, any data item (or set of data items) that is used to authenticate a machine and to determine access permissions to a dataset (e.g., of conference data) by the machine. A token may include, for example and without limitation, a signature, an entry in an access list, or other authentication data.

In some examples of the present disclosure, implementations may include or otherwise use one or more artificial intelligence or machine learning (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

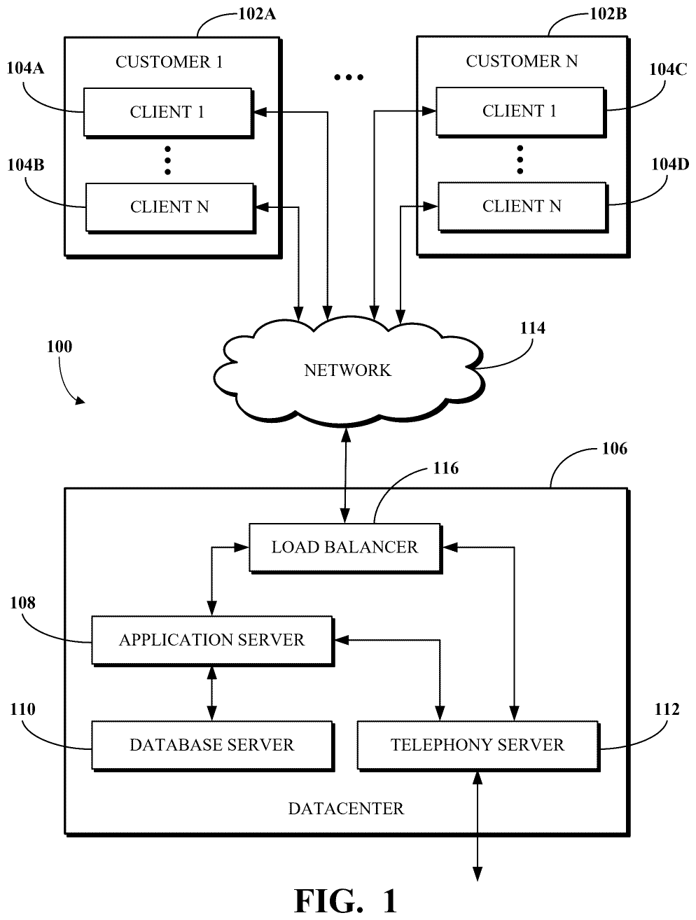

To describe some implementations in greater detail, reference is first made to examples of hardware and software structures used to implement a system for ingesting multimedia data during a conference. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers.

The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

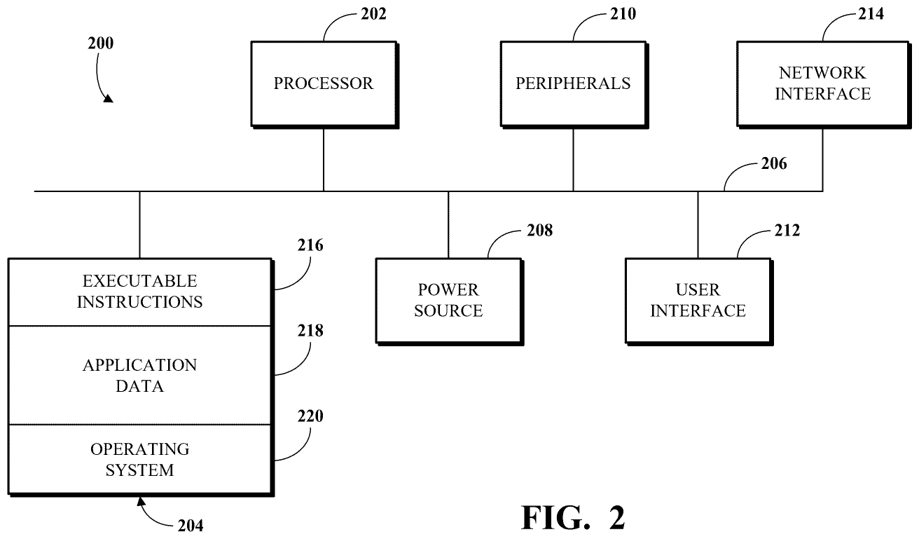

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

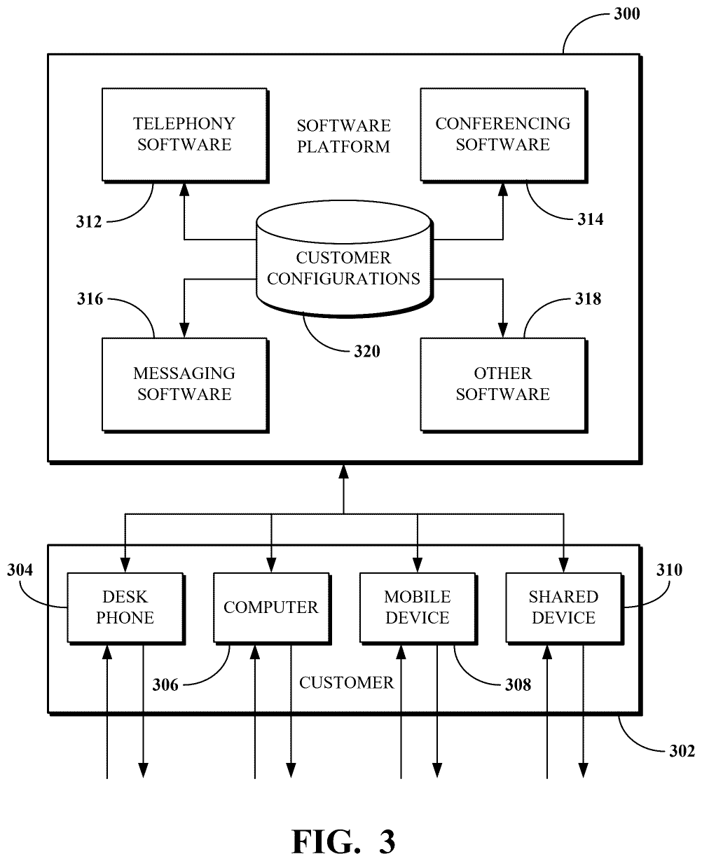

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for ingesting multimedia data during a conference. In some such cases, the conferencing software 314 can include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

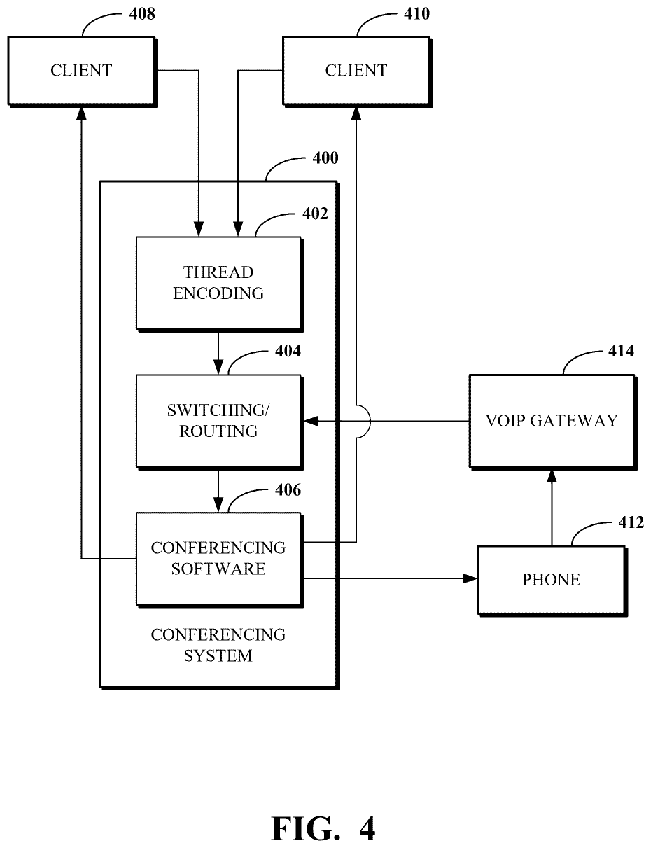

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90 p, 180 p, 360 p, 720 p, and/or 1080 p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 direct the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

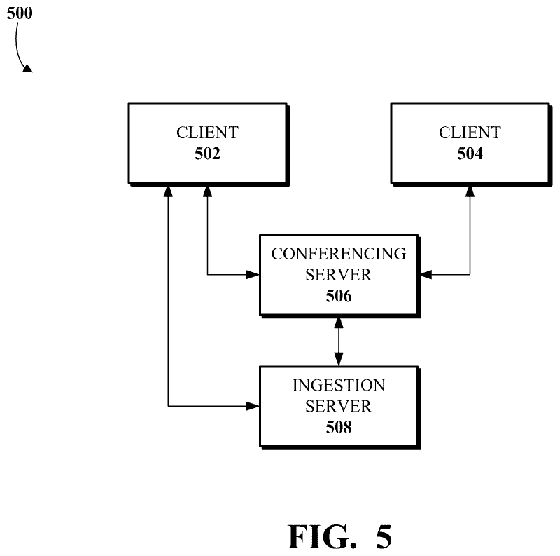

FIG. 5 is a block diagram of an example of a system 500 for ingesting multimedia data during a conference. As shown, the system 500 includes clients 502, 504, a conferencing server 506, and an ingestion server 508. The clients 502, 504 may, for example, correspond to the clients 408, 410. The conferencing server 506 may, for example, be a server of the conferencing system 400 and may include at least one of the thread encoding tool 402, the switching/routing tool 404, or the conferencing software 406. As shown, the ingestion server 508 is connected to the client 502 and may be associated with an organization (e.g., a business) of the client 502 (e.g., an employer of a user of the client 502).

As illustrated, the clients 502, 504 connect to the conferencing server 506 and engage in a conference (e.g., a multimedia conference or a contact center engagement) via the conferencing server 506. The conferencing server 506 receives, from the client 502, a request a request to connect the ingestion server 508 to the conference. The request includes a token for authentication of the ingestion server 508 and an identifier of the ingestion server 508. The token may include an identifier of the client 502 or an account associated with the client 502. The token may specify permissions of the client 502 with respect to the conference (e.g., whether the client 502 has permissions to record visual data or audio data). Alternatively, the token may include a link to an entry in a data repository (e.g., a database) that specifies the permissions. The user of the client 502 may generate the request to connect the ingestion server 508 to the conference in order to execute software (e.g., AI/ML software) stored at the ingestion server 508 on data transmitted during the conference. For example, the ingestion server 508 may include at least one of summarization software, translation software, transcription software, note taking software, or task list generation software. The software stored at the ingestion software 508 may be performed using AI models of the ingestion server 508. The AI models may include at least one of a large language model (LLM), a convolutional neural network (CNN), or another type of AI model.

The conferencing server 506 establishes a communication connection with the ingestion server 508 based on the token. As a result, the ingestion server 508 accesses the conference with access permissions corresponding to those of the client 502. For example, if the client 502 lacks permission to record the conference, the ingestion server 508 would also lack permissions to record the conference.

During the conference, the conferencing server 506 transmits, to the ingestion server 508, at least a portion of the multimedia data of the conference using the established communication connection. The multimedia data that is transmitted via the established communication connection is selected based on the token.

The multimedia data transmitted to the ingestion server 508 may include video streams, audio streams, or other data shared during the conference, such as screen sharing content or chat logs. The ingestion server 508 processes this data to perform one or more tasks specified by the client 502, leveraging its AI/ML capabilities. For example, the ingestion server 508 may process the audio data using speech-to-text technology and generate a real-time transcription of the conference. Additionally, the ingestion server 508 may analyze video streams using computer vision algorithms to identify participants, track their engagement, or detect specific gestures. The processed outputs may be returned to the client 502 or made available for retrieval by other authorized systems, thereby enhancing the conference experience of the user of the client 502.

Furthermore, the ingestion server 508 may support advanced workflows by integrating with other enterprise systems or databases associated with the organization of the client 502. For instance, if the ingestion server 508 generates a task list based on the conference discussion, it could automatically synchronize the task list with a project management tool or send notifications to relevant team members. Similarly, summarization software at the ingestion server 508 might produce condensed meeting summaries that are stored in a knowledge management system for future reference. These functionalities highlight the ability of the ingestion server 508 to act not only as a data processor but also as an enabler of seamless collaboration and productivity.

To maintain security and ensure compliance with data protection regulations, the system 500 implements various safeguards during data transmission and processing. The established communication connection between the conferencing server 506 and the ingestion server 508 is encrypted to prevent unauthorized access to sensitive conference data. Additionally, the ingestion server 508 logs all data access and processing activities for audit purposes, enabling the organization of the client 502 to monitor and verify compliance. These security measures ensure that the system 500 can be deployed in a wide range of applications, including those having stringent privacy and confidentiality standards, such as medical communications or financial communications.

In some implementations, the client 504 may not communicate directly with the ingestion server 506. For example, the client 504 may be associated with an organization that is different from an organization managing the ingestion server 508. In such implementations, the ingestion server 508 may still receive audio or visual data from that is transmitted by the client 504 to the conference via the conferencing server 506.

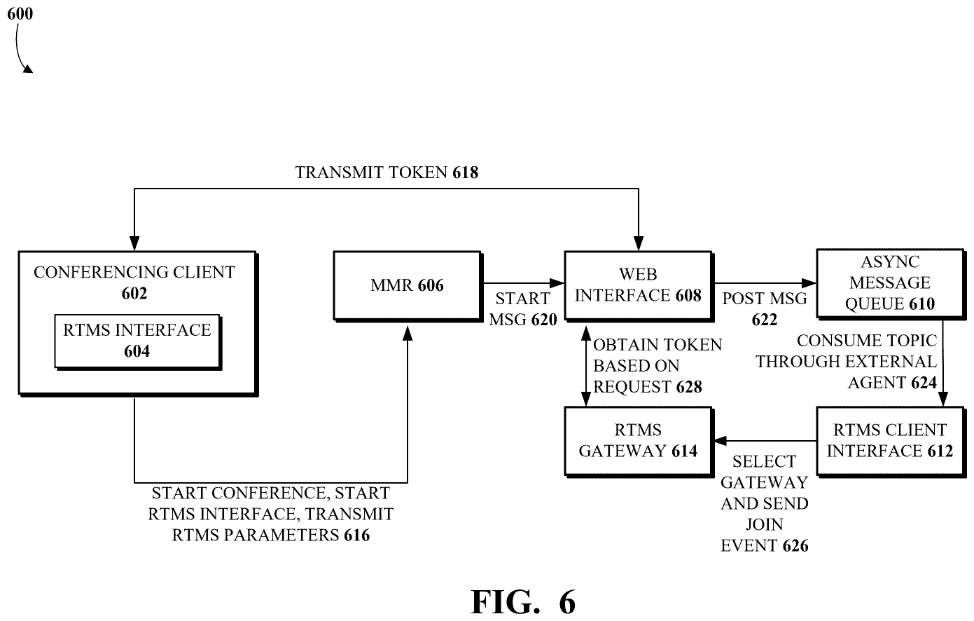

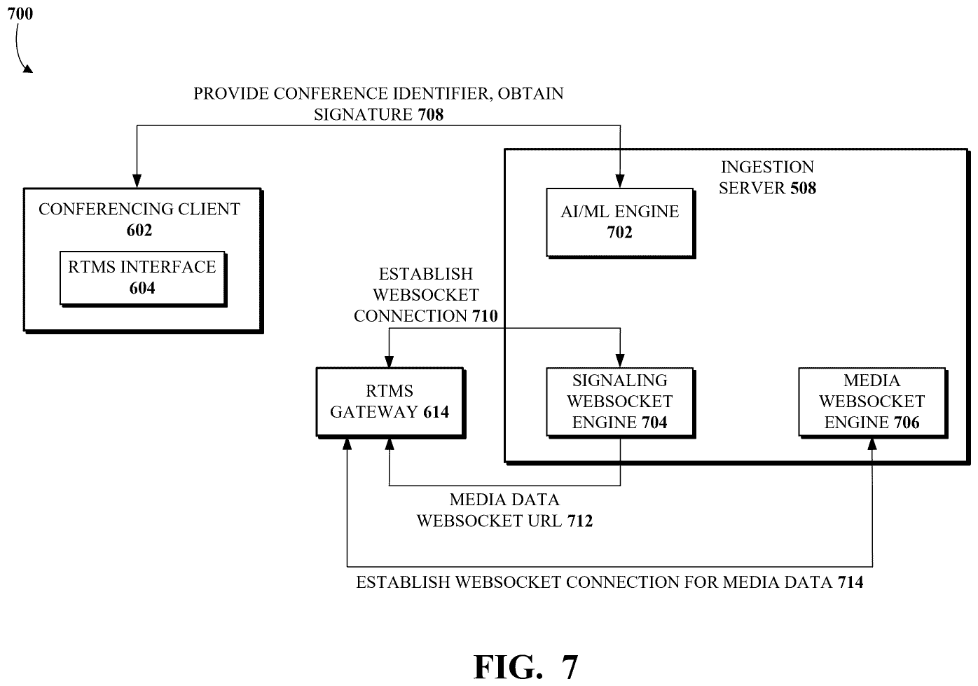

FIGS. 6-7 pertain to a process flow of establishing a real-time media stream (RTMS) during a conference. It outlines a sequence of steps that take place between various components, including the meeting client, RTMS gateway (GW), media WebSocket servers, and signaling WebSocket servers.

A problem addressed by some implementations is the need to efficiently and securely establish real-time media streams (such as audio and potentially video) during a conference. A challenge arises in coordinating the communication between the meeting client and various backend servers in a way that ensures secure data transmission, low latency, and reliable streaming of media content (e.g., mixed audio data).

The solution proposed in FIGS. 6-7 is a systematic technique for setting up and managing the connections necessary to stream media in real time during a conference. The process flow is designed to ensure that appropriate meeting tokens, WebSocket connections, and signatures are used to authenticate and establish media streams, while keeping signaling and media data channels separate. Additionally, the solution is scalable, allowing a WebSocket servers to either be located on the same machine or distributed across different systems, depending on the load or architecture preferences.

FIG. 6 is a data flow diagram 600 of ingesting multimedia data during a conference. As shown, the data flow diagram 600 includes a conferencing client 602, which includes a RTMS interface 604. The conferencing client 602 may correspond to the client 502. The data flow diagram 600 includes a meeting management router (MMR) 606, a web interface 608, an asynchronous (async) message queue 610, a RTMS client interface 612, and a RTMS gateway 614. The MMR 606, the web interface 608, the async message queue 610, the RTMS client interface 612, and the RTMS gateway 614 may reside at the conferencing server 506. The conferencing server 506 facilitates real-time communication and interaction between multiple conferencing clients by managing multimedia data streams, access permissions, and data routing.

The web interface 608 operates as a component within the conferencing server architecture, enabling the initiation and management of multimedia data ingestion during a conference. Specifically, the web interface 608 functions to receive and process start messages transmitted by the MMR 606, subsequently facilitating the transmission of relevant instructions and conference data to downstream components, such as the asynchronous message queue 610. The web interface 608 plays a role in ensuring the seamless routing of data streams, as it manages the interaction between the conferencing client 602 and the RTMS infrastructure, thereby supporting the efficient delivery of audio, video, and metadata to connected entities, for example, the ingestion server 508.

At 616, the conferencing client transmits, to the MMR, a signal to start a conference and to start a RTMS interface. This signal may include initialization parameters such as session identifiers, authentication credentials, and requested media types (e.g., audio, video, or both). At 616, the conferencing client also transmits RTMS parameters to the MMR 606, which may include encoding formats, bitrates, and network protocol preferences to optimize the data flow for the conference environment.

At 618, the conferencing client 602 transmits a token representing permissions or settings for the ingestion server 508 to access the conference. The permissions may be determined based on a video conferencing account of the user of the conferencing client 602. The settings may be determined based on an application executing on the ingestion server 508. For example, a summarization application executing on the ingestion server 508 (that generates a summary of the conference) may have different settings from a translation application executing on the ingestion server (that translates the conference from one natural language to another). The token may include metadata such as time-stamped permissions, allowed data types (e.g., video or audio), and specific ingestion server capabilities.

At 620, the MMR 606 transmits a start message to the web interface 608, causing conference data transmission to the ingestion server 508 to start. This start message may include a session identifier and an encryption key for secure data transmission.

At 622, the web interface 608 transmits a post message to the async message queue 610. The post message includes instructions for routing conference data and may include payloads such as media packet headers, participant information, and topic classifications.

At 624, the async message queue 610 consumes a topic through an external agent and sends the consumed topic to the RTMS client interface 612. The topic may correspond to a subset of the multimedia data of the conference, identified based on the token, that is to be transmitted to the ingestion server 508. For instance, the topic may specify video data streams for a particular participant or sections of the audio relevant to specific meeting agenda items.

At 626, the RTMS client interface 612 selects a gateway and sends a join event for the ingestion server to join the conference (e.g., receive data from the conference). The gateway selection process may involve evaluating network latency, bandwidth availability, and geographic proximity to optimize performance.

At 628, the RTMS gateway 614 requests a token from the web interface 608 and obtains the token based on the request. The token retrieval process ensures compliance with the session's security protocols, verifying the permissions and session validity before granting access.

FIG. 7 is a data flow diagram 700 of ingesting multimedia data during a conference. The data flow diagram 700 may be executed together with the data flow diagram 600, for example, the operations in the data flow diagram 700 may be executed after, before, or in parallel with the operations in the data flow diagram 600. As shown, the data flow diagram 700 includes the conferencing client 602, the RTMS interface 604, and the RTMS gateway 614 of FIG. 6. The data flow diagram 700 also includes the ingestion server 508, which includes an AI/ML engine 702, a signaling WebSocket engine 704, and a media WebSocket engine 706. The AI/ML engine 702, the signaling WebSocket engine 704, and the media WebSocket engine 706 may reside on different servers of the ingestion server 508 (which may include multiple servers). Alternatively, two or more of the AI/ML engine 702, the signaling WebSocket engine 704, and the media WebSocket engine 706 may reside on the same server. This configuration enables scalability and flexibility in handling diverse conferencing data, optimizing load balancing across server resources.

The AI/ML engine 702 executes AI/ML inferencing technology based on multimedia data (or other data) of the conference. The multimedia data may include audio, video, and shared screen content, as well as metadata such as timestamps and speaker identification. For example, the AI/ML engine 702 may generate a transcript or a summary of the conference. In another example, the AI/ML engine 702 takes notes on behalf of the user of the conferencing client 602. For example, if the AI/ML engine 702 has access to information (e.g., in an employee database) indicating that the user is an accountant, the AI/ML engine 702 may generate detailed notes associated with discussions of taxes or accounting in the conference and may generate less detailed notes regarding other parts of the conference. Additionally, the AI/ML engine 702 may classify discussions by topic, identify action items, and highlight key decisions for enhanced post-meeting usability.

The signaling WebSocket engine 704 manages signaling operations, including session initiation, participant coordination, and real-time communication protocol exchanges. It enables the establishment and maintenance of WebSocket connections between the ingestion server 508 and other entities, such as the RTMS gateway 614. Specifically, the signaling WebSocket engine 704 handles message routing to ensure synchronization between conference participants and provides acknowledgments for communication events.

The media WebSocket engine 706 handles the real-time transmission of multimedia data streams, including encoding, decoding, and packetization processes necessary for conference media delivery. It facilitates the reception and forwarding of media data, such as audio, video, and shared content, between the ingestion server 508 and external systems like the RTMS gateway 614. Additionally, the media WebSocket engine 706 may optimize media stream quality by adjusting bitrate and resolution based on network conditions.

At 708, the conferencing client provides a conference identifier of the conference to the AI/ML engine 702. The conferencing client obtains a signature of the AI/ML engine 702 to verify the authenticity of the AI/ML engine 702 prior to connection of the AI/ML engine 702 to the conference. The conference identifier may include unique metadata such as session identifiers, participant lists, and timestamps to ensure accurate context for the operations of the AI/ML engine 702. The signature verification ensures secure and trusted interactions with the AI/ML engine 702.

At 710, the signaling WebSocket engine 704 establishes a WebSocket connection (e.g., a bidirectional WebSocket connection) with the RTMS gateway 614. This connection involves an initial handshake protocol, wherein the signaling WebSocket engine 704 sends a connection request to the RTMS gateway 614, which includes parameters such as a session token, encryption keys, and authentication credentials. The handshake ensures that the RTMS gateway 614 verifies the identity of the signaling WebSocket engine 704 and authorizes its access to the conference resources. Upon successful verification, the RTMS gateway 614 responds with an acknowledgment message, completing the connection establishment. Additionally, the signaling WebSocket engine 704 monitors the status of the WebSocket connection, periodically transmitting keep-alive messages to prevent timeouts and ensure that the communication channel remains active throughout the conference.

At 712, the signaling WebSocket engine 704 transmits a media data WebSocket uniform resource locator (URL) to the RTMS gateway 614. The URL specifies the endpoint for the media WebSocket engine 706 to facilitate the transmission of multimedia data streams. The media data WebSocket URL includes information such as the protocol type (e.g., wss:// for secure WebSocket communication), the host address, the port number, and query parameters defining the session context. For example, the URL may contain an embedded token for session authentication, a reference to the specific conference identifier, and quality-of-service (QoS) parameters that prioritize audio over video for low-bandwidth scenarios. Additionally, the signaling WebSocket engine 704 ensures that the media data WebSocket URL is encrypted before transmission to maintain data security and prevent unauthorized access.

At 714, the media WebSocket engine 706 and the RTMS gateway 614 establish a WebSocket connection (e.g., a bidirectional WebSocket connection) for media data of the conference based on the URL. This process begins with the media WebSocket engine 706 resolving the provided URL to identify the RTMS gateway 614 endpoint and initiating a connection request. The request may include headers specifying the desired media types (e.g., audio, video, or shared screen content), supported codecs (e.g., H.264 for video, Opus for audio), and network conditions such as available bandwidth. Once the connection is established, the media WebSocket engine 706 and the RTMS gateway 614 synchronize their protocols to initiate the exchange of multimedia data packets. During this exchange, the media WebSocket engine 706 implements error-checking mechanisms, such as packet retransmission for lost data and jitter buffering to ensure smooth playback. Additionally, the media WebSocket engine 706 dynamically adjusts encoding parameters, such as bitrate and resolution, based on real-time feedback from the RTMS gateway 614 to optimize the quality of the media streams under varying network conditions. Furthermore, the connection supports bi-directional communication, enabling the RTMS gateway 614 to send acknowledgments, control signals, or requests for retransmission to the media WebSocket engine 706 as necessary to maintain high data integrity.

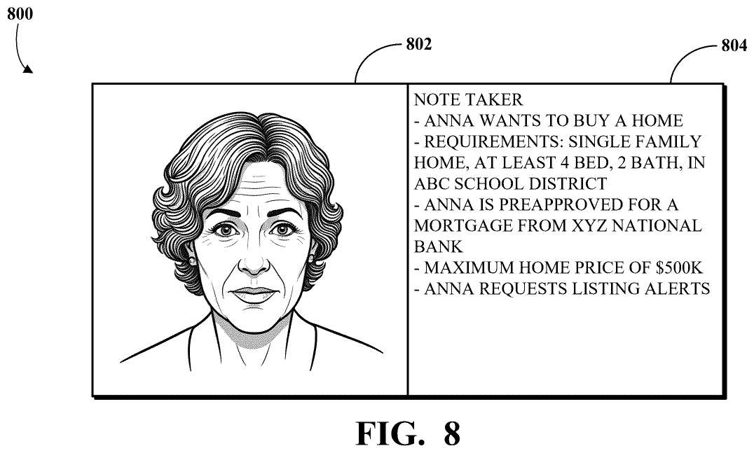

FIG. 8 illustrates a graphical user interface (GUI) 800 for artificial intelligence-enhanced video conferencing. The GUI 800 may be displayed at a client device (e.g., the client 502 or the conferencing client 602) that is connected to a conference and leveraging the functionality of the ingestion server 508. As shown, the GUI 800 includes a video feed 802 and AI-generated data 804. The GUI 800 is designed to present real-time conference information in an intuitive layout, integrating video and AI-generated insights for enhanced user engagement.

The video feed 802 includes video imagery associated with the conference. As shown, the video feed 802 includes camera-generated data. The camera-generated data may include live video streams of conference participants captured via built-in or external webcams. In some cases, the video feed 802 may include shared screen data. The shared screen data may include documents, presentation slides, or software demonstrations shared by one or more participants during the conference. The video feed 802 may also incorporate overlays, such as participant names, speaking indicators, or real-time transcription text synchronized with the audio stream. Additionally, the video feed 802 may provide customizable options, allowing the user to switch between active speaker view, gallery view, and shared content view, depending on the user's preference.

As shown, the AI-generated data 804 includes notes generated by an AI-based note taker. The AI-based note taker utilizes the AI/ML engine 702 of the ingestion server 508 to process audio, video, and textual inputs in real time. The notes may be dynamically updated during the conference to reflect ongoing discussions and action items. In the example illustrated in FIG. 8, a prospective client named Anna is communicating with a real estate agent about a home purchase. The real estate agent is the user of the client device. As shown, the AI-generated notes are displayed in a side panel within the GUI 800, and they include relevant details such as Anna's preferences, budget, and locations of interest. The notes generated by the AI-based note taker include information that may be useful to the real estate agent in working with Anna. For example, the notes may highlight key questions raised by Anna, summarize her feedback on specific property listings, and identify follow-up actions, such as scheduling property tours or sending additional information. The AI-generated data 804 may also include contextual insights, such as market trends or property comparisons, that are relevant to the ongoing discussion. The contextual insights may be obtained from Internet-based sources (e.g., multiple listing service data or blog posts about the real estate market) outside of the conference.

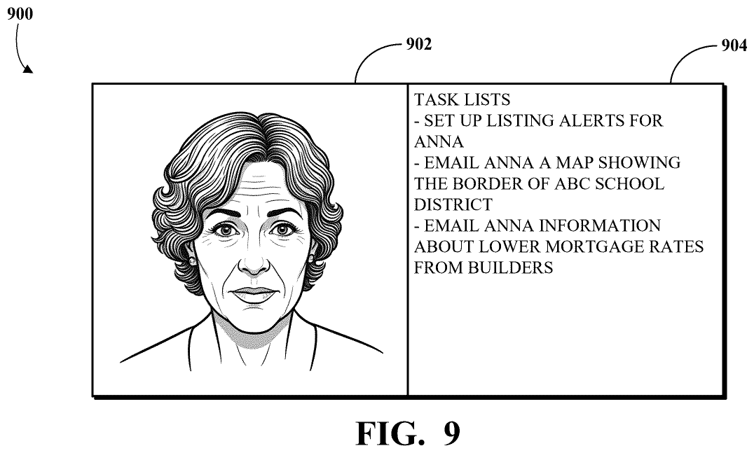

FIG. 9 illustrates a GUI 900 for artificial intelligence-enhanced video conferencing. The GUI 900 may be displayed at a client device (e.g., the client 502 or the conferencing client 602) that is connected to a conference and leveraging the functionality of the ingestion server 508. As shown, the GUI 900 includes a video feed 902 and AI-generated data 904. The GUI 900 builds upon the functionality described for the GUI 800, offering an interactive interface that adapts to the specific requirements of different use cases. The GUI 800 is designed to present real-time conference information in an intuitive layout, integrating video and AI-generated insights for enhanced user engagement. As shown, the video feed 902 has functionality similar to that of the video feed 802. In addition to displaying video imagery, the video feed 902, similar to the video feed 802, may support advanced features such as background blurring, virtual backgrounds, and video quality optimization based on available network bandwidth.

However, the AI-generated data 904 includes a task list rather than notes for the real estate agent. The task list is dynamically generated by the AI/ML engine 702 of the ingestion server 508, which processes audio, visual, and contextual data from the conference to identify actionable items. The task list may be generated by the AI/ML engine 702 based on audio or visual data of the conference. For example, the AI/ML engine 702 may analyze spoken dialogue, visual cues (e.g., shared screen content), or metadata (e.g., timestamps and participant identifiers) to extract and prioritize tasks. As shown, the task list includes the tasks of setting up listing alerts for Anna, emailing Anna a map showing the border of ABC school district, and emailing Anna information about lower mortgage rates from builders. As shown, each task is displayed in a list of tasks. In alternative implementations, each task may be displayed with a description, a priority level, and optional due dates or deadlines to assist the real estate agent in managing their follow-ups efficiently. The task list may also include interactive elements, such as checkboxes for marking tasks as complete, and links or buttons for performing related actions (e.g., sending an email or accessing relevant documents).

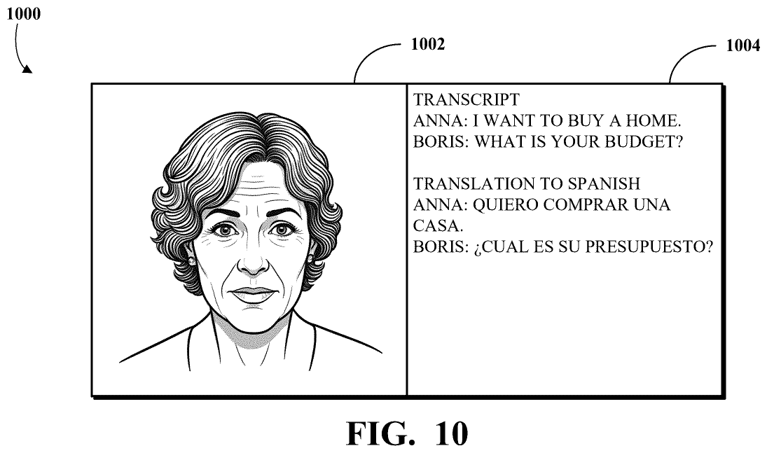

FIG. 10 illustrates a GUI 1000 for artificial intelligence-enhanced video conferencing. The GUI 1000 may be displayed at a client device (e.g., the client 502 or the conferencing client 602) that is connected to a conference and leveraging the functionality of the ingestion server 508. Similar to the GUI 800 and the GUI 900, the GUI 1000 includes a video feed 1002 and AI-generated data 1004. The video feed 1002 has a functionality similar to that of the video feed 802 and the video feed 902.

In FIG. 10, the AI-generated data 1004 includes a transcript of the conference and a translation of the transcript from English into Spanish. The transcript is generated by the AI/ML engine 702, which processes the audio data of the conference in real time, leveraging natural language processing (NLP) algorithms to identify and transcribe spoken words. This transcript might assist a user of the client device (e.g., a family member of the prospective client of the real estate agent) who speaks Spanish and does not speak English fluently in understanding what is transpiring in the conference.

The translation functionality utilizes machine translation models within the AI/ML engine 702 to convert the English transcript into Spanish while maintaining contextual accuracy and semantic integrity. In some implementations, the AI-generated data 1004 may also include timestamps synchronized with the video feed 1002, allowing users to easily correlate specific sections of the transcript with the corresponding parts of the conference. Additionally, the GUI 1000 may enable users to select alternate languages for translation, providing further accessibility for diverse audiences. For example, a French-speaking user might have the conference translated into French rather than Spanish.

The GUI 1000 is designed to accommodate multilingual participants, providing tools for real-time transcription and translation to facilitate communication across language barriers. In alternative implementations, in addition to displaying live video imagery, the video feed 1002 may support participant tagging (e.g., identifying the current speaker) and integrating transcription overlays (e.g., either in English or in Spanish) directly into the video stream for ease of viewing.

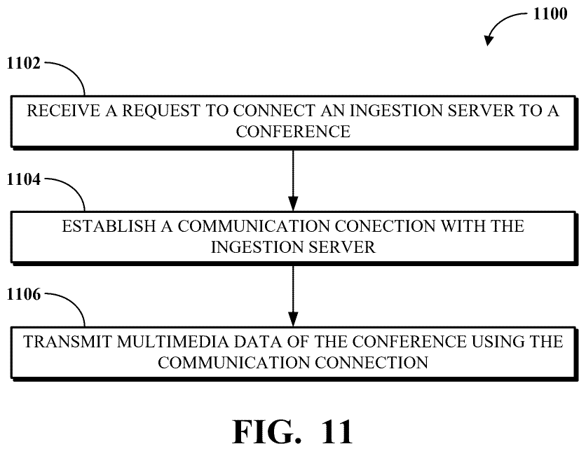

To further describe some implementations in greater detail, reference is next made to examples of techniques which may be performed by or using a system for ingesting multimedia data during a conference. FIG. 11 is a flowchart of an example of a technique 1100 for ingesting multimedia data during a conference. The technique 1100 can be executed using computing devices, such as the systems, hardware, and software described with respect to FIGS. 1-10. The technique 1100 can be performed, for example, by executing a machine-readable program or other computer-executable instructions, such as routines, instructions, programs, or other code.

The steps, or operations, of the technique 1100, or another technique, method, process, or algorithm described in connection with the implementations disclosed herein can be implemented directly in hardware, firmware, software executed by hardware, circuitry, or a combination thereof.

For simplicity of explanation, the technique 1100 is depicted and described herein as a series of steps or operations. However, the steps or operations of the technique 1100 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

FIG. 11 illustrates the technique 1100 for ingesting multimedia data during a conference. The technique 1100 may be performed by a conferencing server, which may be, for example, the conferencing server 506. The technique 1100 enables the efficient, secure, and scalable ingestion of multimedia data for analysis, storage, or downstream processing by external systems.

At 1102, the conferencing server receives, from a client device (e.g., the client 502), a request to connect an ingestion server (e.g., the ingestion server 508) to a conference to which the client device is connected. The request includes a token for authenticating the ingestion server and an identifier of the ingestion server. The token may include encrypted credentials, expiration timestamps, and access scopes that define the data the ingestion server is authorized to access. This request can be initiated by the client device through various communication channels or interfaces provided by the conferencing application. In some implementations, the request to connect the ingestion server is received in conjunction or in parallel with another request to connect the client device to the conference. That is, when the client device joins the conference, the client device can simultaneously request that an ingestion server be connected, facilitating real-time data processing or recording. This integration reduces latency and ensures seamless operation by synchronizing the ingestion server's setup with the conference initialization. In some examples, the user interface for connecting to the conference, at the client device, prompts the user of the client device to indicate whether to connect an ingestion server of their organization to the conference. This user interface may include options to configure specific ingestion server tasks, such as transcription, translation, or data summarization.

At 1104 the conferencing server establishes, based on the token, a communication connection with the ingestion server. The token serves to authenticate the ingestion server, ensuring that only authorized ingestion servers can receive conference data. The communication connection can be established over a network using secure protocols. For example, the connection may employ transport layer security (TLS) to encrypt data transmission and prevent unauthorized access. In some implementations, the communication connection comprises at least one WebSocket connection. WebSocket connections provide full-duplex communication channels over a single transmission control protocol (TCP) connection, allowing for efficient real-time data exchange between the conferencing server and the ingestion server. The conferencing server may also implement error recovery mechanisms, such as retry logic and session state restoration, to maintain reliable communication.

In some implementations, the multimedia data comprises audio data, visual data, and metadata, and the communication connection includes a first WebSocket connection for the audio data and a second WebSocket connection for the visual data and the metadata. This separation ensures that latency-sensitive audio data is prioritized while larger visual data packets are transmitted concurrently without interruption. By separating the data streams, the system can optimize bandwidth usage and ensure that different types of data are transmitted efficiently. It should be noted that other separations of data streams may be used. For example, there may be a first WebSocket connection for the audio data, a second WebSocket connection for the visual data, and a third WebSocket connection for the metadata. Alternatively, there may be a single WebSocket connection that is shared by the audio data, the visual data, and the metadata. The choice of connection structure may depend on network conditions, client device capabilities, or ingestion server requirements. In some cases, at least one of the audio data, the visual data, or the metadata might not be transmitted to the ingestion server. For example, if the ingestion server is configured solely for transcription, audio data may be transmitted, while visual data might not be transmitted.

It should be noted that WebSocket is one example of a protocol that could be used in some implementations. In some aspects, a different protocol may be used in conjunction with or in place of WebSocket. For instance, QUIC (Quick UDP Internet Connections) or HTTP/2 (hypertext transfer protocol/2) streams could provide enhanced performance and reliability in certain network environments. In some cases, a transmission control protocol (TCP) WebSocket for the audio connection, and other data (e.g., visual data or metadata) is handled over user datagram protocol (UDP) or another protocol. This hybrid approach allows the system to balance reliability and speed by leveraging TCP for critical data and UDP for time-sensitive but less critical data.

At 1106, the conferencing server transmits, to the ingestion server, at least a portion of the multimedia data of the conference using the communication connection based on the token. The transmitted portion may include pre-processed or compressed data to reduce transmission time and bandwidth consumption. The portion of the multimedia data transmitted can be determined based on a requested portion indicated in the request and the privacy settings and/or data sharing permissions of other client devices (or user accounts associated with the client devices) connected to the conference. This ensures that only authorized data is transmitted to the ingestion server in accordance with privacy policies and/or data sharing policies. For example, a client device connected to the conference may restrict access to video data from that client device while allowing audio data to be shared.

In some implementations, the multimedia data comprises multiple multimedia streams from multiple client devices connected to the conference, with each multimedia stream (or at least one of the multimedia streams) including an identifier of the source client device. The identifier may include information such as user IDs, device IDs, or session IDs to facilitate data tracking and attribution. This allows the ingestion server to identify and process the data streams from each participant individually. One or more of the source client devices may be different from the client device that requested the connection to the ingestion server. This enables collaborative use cases where one participant initiates the connection, but data from multiple participants is processed.

In some implementations, the conferencing server may establish multiple communication connections with multiple ingestion servers, including the ingestion server, and communicate with the multiple ingestion servers in parallel or simultaneously. Parallel communication enables simultaneous processing tasks, such as transcription, translation, and sentiment analysis, by separate ingestion servers. This capability allows the conferencing server to distribute the multimedia data to various ingestion servers simultaneously, which can be useful for scaling, redundancy, or distributing different data to different processing systems. In some examples, the multiple ingestion servers are associated with different organizations. For example, client A from organization A and client B from organization B may be engaged in a conference together. The user of client A may request that the ingestion server of organization A generate a transcript of the conference for organization A's records. The user of client B may request that the ingestion server of organization B apply an artificial intelligence engine to generate insights and take-home points from the conference for the user of client B. This multi-organization setup ensures that sensitive data remains within the boundaries of each organization while enabling inter-organizational collaboration.

In some implementations, the conferencing server grants the ingestion server access permissions to the conference based, at least, on the access permissions of the client device (e.g., granted to the client device) from which the request is received. These permissions may include read-only access, the ability to process specific media types, or restrictions on data retention. For example, if the client device has certain privileges or permissions within the conference, these can be extended to the ingestion server, ensuring consistent access control.

The conferencing server may also store at least a portion of the multimedia data from the conference for later retrieval. The stored data may include additional metadata, such as timestamps, participant logs, or annotations, to enhance post-conference analysis. Upon receiving a request to access the stored portion of the multimedia data, the conferencing server transmits the stored portion to the ingestion server in response to the request. This feature allows the ingestion server to access past conference data, which may be useful for post-processing or analysis. It should be noted that user consent and indicators in this scenario may mirror, leverage or build upon existing recording disclosures, consent and indicators presented to both end users (in client conferencing software) and account administrators. Furthermore, there may be multiple techniques by which the recorded media may be consumed by the ingestion server, both during the conference and after the conference. For example, in some cases, a portion of the recorded media may be provided to the ingestion server during night, weekend, or holiday hours when there is lower (e.g., below as threshold amount of) demand for at least one of network access, the conferencing server, or the ingestion server.

In some implementations, the conferencing server prompts client devices connected to the conference to generate an indication of user consent to transmit multimedia data to the ingestion server. The prompt may include detailed information on what data will be shared, how it will be used, and the duration of retention. This can be implemented via a prompt or notification requesting users to agree to their data being shared with the ingestion server. The conferencing server then receives the indications of user consent from a subset of the client devices and transmits the multimedia data of only the consenting devices to the ingestion server. This ensures compliance with privacy regulations and respects user preferences.

In certain scenarios, the client device is associated with an organization, and the identifier of the ingestion server corresponds to an identifier of the organization. This linkage enables centralized management of ingestion server configurations, permissions, and operational policies within the organization. This association facilitates the management and authentication of ingestion servers within organizational boundaries, ensuring that data sharing complies with organizational policies and security requirements.

An example use case of the disclosed technology may be implemented in a contact center, where contact center agents communicate with contact center users via video conferencing, and the ingestion server is used for sentiment analysis of the contact center users. During a video conference, the conferencing client of the contact center agent captures multimedia data, including video, audio, and metadata such as timestamps, participant identifiers, and session context. This data is transmitted to the conferencing server, which authenticates the ingestion server using a token provided during the session initialization with the conferencing client of the contact center agent. The conferencing server then establishes a secure WebSocket connection with the ingestion server and transmits the multimedia data in real time. At the ingestion server, the audio data is processed through a speech-to-text engine to generate a transcript of the conversation, while the video data is analyzed using facial expression recognition algorithms to extract non-verbal cues such as smiles, frowns, or other emotions. Both text and visual data are input into a sentiment analysis module, powered by an AI/ML engine, to determine the emotional tone and sentiment (e.g., positive, negative, neutral) of the contact center user. The analysis results, including sentiment scores, key phrases, and detected emotions, are packaged with metadata such as timestamps and session identifiers and transmitted to the agent's conferencing client, where it is displayed in real time as part of the GUI. For example, the GUI may show a dynamic sentiment chart or actionable insights, such as suggestions for the agent to adjust their tone or respond to specific concerns. This continuous loop enables the agent to adapt their approach during the interaction, improving customer satisfaction and efficiency.

Another example use case of this technology in a contact center setting could involve improving customer interactions by providing real-time insights to agents during video calls. As a customer speaks with an agent about a product issue, the system analyzes the customer's tone, word choice, and facial expressions to detect frustration or satisfaction. This information is instantly processed and displayed to the agent in an easy-to-read format, such as a “sentiment meter” or actionable tips, like, “The customer seems frustrated; acknowledge their concerns.” If the sentiment analysis detects positive emotions, the system might suggest upselling opportunities or asking for feedback. These insights help the agent respond more effectively, ensuring the customer feels heard and valued. The end result is higher customer satisfaction, improved agent performance, and the potential for increased revenue through better engagement.

Some implementations are described below as numbered examples (Example 1, 2, 3, etc.). These examples are provided as examples only and do not limit the other implementations disclosed herein.

Example 1 is a method, comprising: receiving, by a conferencing server and from a client device, a request to connect an ingestion server to a conference to which the client device is connected, the request comprising a token for authentication of the ingestion server and an identifier of the ingestion server; establishing, by the conferencing server and based on the token, a communication connection with the ingestion server; and transmitting, by the conferencing server and to the ingestion server, at least a portion of multimedia data of the conference using the communication connection based on the token.

In Example 2, the subject matter of Example 1 includes, wherein the communication connection comprises at least one WebSocket connection.

In Example 3, the subject matter of Examples 1-2 includes, wherein the multimedia data comprises audio data, visual data, and metadata, and wherein the communication connection comprises a first WebSocket connection for the audio data and a second WebSocket connection for the visual data and the metadata.

In Example 4, the subject matter of Examples 1-3 includes, wherein receiving the request comprises: receiving the request in conjunction with another request to connect the client device to the conference.

In Example 5, the subject matter of Examples 1-4 includes, determining the portion of the multimedia data for transmission to the ingestion server based on a requested portion of the multimedia data indicated in the request, and privacy settings of at least one client device, different from the client device, that is connected to the conference.

In Example 6, the subject matter of Examples 1-5 includes, wherein the multimedia data comprises multiple multimedia streams from multiple client devices connected to the conference, wherein at least one multimedia stream of the multiple multimedia streams includes an identifier of a source client device of the multimedia stream.

In Example 7, the subject matter of Examples 1-6 includes, establishing, by the conferencing server, multiple communication connections with multiple ingestion servers, including the ingestion server; and communicating, by the conferencing server, with the multiple ingestion servers in parallel.

In Example 8, the subject matter of Examples 1-7 includes, granting, to the ingestion server, access permissions to the conference based, at least, on access permissions to the conference of the client device from which the request is received.

In Example 9, the subject matter of Examples 1-8 includes, storing, by the conferencing server, at least a portion of the multimedia data from the conference for later retrieval; receiving, by the conferencing server, a request to access the stored portion of the multimedia data; and transmitting, by the conferencing server and to the ingestion server, the stored portion of the multimedia data in response to the request.

In Example 10, the subject matter of Examples 1-9 includes, prompting, by the conferencing server, client devices connected to the conference to generate an indication of user consent to transmit multimedia data to the ingestion server; receiving, by the conferencing server and from a subset of the client devices, the indication of the user consent; and transmitting, by the conferencing server and to the ingestion server, the multimedia data of the subset of the client devices.

In Example 11, the subject matter of Examples 1-10 includes, wherein the client device is associated with an organization, wherein the identifier of the ingestion server corresponds to an identifier of the organization.

Example 12 is a non-transitory computer readable medium storing instructions operable to cause one or more processors to perform operations comprising: receiving, by a conferencing server and from a client device, a request to connect an ingestion server to a conference to which the client device is connected, the request comprising a token for authentication of the ingestion server and an identifier of the ingestion server; establishing, by the conferencing server and based on the token, a communication connection with the ingestion server; and transmitting, by the conferencing server and to the ingestion server, at least a portion of multimedia data of the conference using the communication connection based on the token.

In Example 13, the subject matter of Example 12 includes, wherein the communication connection comprises at least one bidirectional WebSocket connection.

In Example 14, the subject matter of Examples 12-13 includes, wherein the multimedia data comprises audio data and visual data, and wherein the communication connection comprises a first WebSocket connection for the audio data and a second WebSocket connection for the visual data.

In Example 15, the subject matter of Examples 12-14 includes, wherein receiving the request comprises: receiving the request in parallel with a second request to connect the client device to the conference.

In Example 16, the subject matter of Examples 12-15 includes, the operations further comprising: determining the portion of the multimedia data for transmission to the ingestion server based on a requested portion of the multimedia data indicated in the request, and privacy settings associated with a user account of at least one client device, different from the client device, that is connected to the conference.

In Example 17, the subject matter of Examples 12-16 includes, wherein the multimedia data comprises at least one multimedia stream that includes an identifier of a source client device of the multimedia stream.

Example 18 is a system, comprising: a memory subsystem storing instructions; and processing circuitry configured to execute the instructions to: receive, by a conferencing server and from a client device, a request to connect an ingestion server to a conference to which the client device is connected, the request comprising a token for authentication of the ingestion server and an identifier of the ingestion server; establish, by the conferencing server and based on the token, a communication connection with the ingestion server; and transmit, by the conferencing server and to the ingestion server, at least a portion of multimedia data of the conference using the communication connection based on the token.

In Example 19, the subject matter of Example 18 includes, the processing circuitry further configured to execute the instructions to: establish multiple communication connections with multiple ingestion servers, including the ingestion server; and simultaneously communicate, by the conferencing server, with the multiple ingestion servers.

In Example 20, the subject matter of Examples 18-19 includes, the processing circuitry further configured to execute the instructions to: grant, to the ingestion server, access permissions to the conference based, at least, on access permissions to the conference granted to the client device.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

As used herein, the term “and/or” encompasses its plain and ordinary meaning and may refer to either an intersection or a union of sets of data. In a first example, the phrase “A and/or B” encompasses the intersection of A and B. In a second example, the phrase “A and/or B”encompasses the union of A and B.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, by a conferencing server and from a client device, a request to connect an ingestion server to a conference to which the client device is connected, the request comprising a token for authentication of the ingestion server and an identifier of the ingestion server;
establishing, by the conferencing server and based on the token, a communication connection with the ingestion server; and
transmitting, by the conferencing server and to the ingestion server, at least a portion of multimedia data of the conference using the communication connection based on the token.

2. The method of claim 1, wherein the communication connection comprises at least one WebSocket connection.

3. The method of claim 1, wherein the multimedia data comprises audio data, visual data, and metadata, and wherein the communication connection comprises a first WebSocket connection for the audio data and a second WebSocket connection for the visual data and the metadata.

4. The method of claim 1, wherein receiving the request comprises:
receiving the request in conjunction with another request to connect the client device to the conference.

5. The method of claim 1, further comprising:
determining the portion of the multimedia data for transmission to the ingestion server based on a requested portion of the multimedia data indicated in the request, and privacy settings of at least one client device, different from the client device, that is connected to the conference.

6. The method of claim 1, wherein the multimedia data comprises multiple multimedia streams from multiple client devices connected to the conference, wherein at least one multimedia stream of the multiple multimedia streams includes an identifier of a source client device of the multimedia stream.

7. The method of claim 1, further comprising:
establishing, by the conferencing server, multiple communication connections with multiple ingestion servers, including the ingestion server; and
communicating, by the conferencing server, with the multiple ingestion servers in parallel.

8. The method of claim 1, further comprising:
granting, to the ingestion server, access permissions to the conference based, at least, on access permissions to the conference of the client device from which the request is received.

9. The method of claim 1, further comprising:
storing, by the conferencing server, at least a portion of the multimedia data from the conference for later retrieval;
receiving, by the conferencing server, a request to access the stored portion of the multimedia data; and
transmitting, by the conferencing server and to the ingestion server, the stored portion of the multimedia data in response to the request.

10. The method of claim 1, further comprising:
prompting, by the conferencing server, client devices connected to the conference to generate an indication of user consent to transmit multimedia data to the ingestion server;
receiving, by the conferencing server and from a subset of the client devices, the indication of the user consent; and
transmitting, by the conferencing server and to the ingestion server, the multimedia data of the subset of the client devices.

11. The method of claim 1, wherein the client device is associated with an organization, wherein the identifier of the ingestion server corresponds to an identifier of the organization.

12. A non-transitory computer readable medium storing instructions operable to cause one or more processors to perform operations comprising:
receiving, by a conferencing server and from a client device, a request to connect an ingestion server to a conference to which the client device is connected, the request comprising a token for authentication of the ingestion server and an identifier of the ingestion server;
establishing, by the conferencing server and based on the token, a communication connection with the ingestion server; and
transmitting, by the conferencing server and to the ingestion server, at least a portion of multimedia data of the conference using the communication connection based on the token.

13. The non-transitory computer readable medium of claim 12, wherein the communication connection comprises at least one bidirectional WebSocket connection.

14. The non-transitory computer readable medium of claim 12, wherein the multimedia data comprises audio data and visual data, and wherein the communication connection comprises a first WebSocket connection for the audio data and a second WebSocket connection for the visual data.

15. The non-transitory computer readable medium of claim 12, wherein receiving the request comprises:
receiving the request in parallel with a second request to connect the client device to the conference.

16. The non-transitory computer readable medium of claim 12, the operations further comprising:
determining the portion of the multimedia data for transmission to the ingestion server based on a requested portion of the multimedia data indicated in the request, and privacy settings associated with a user account of at least one client device, different from the client device, that is connected to the conference.

17. The non-transitory computer readable medium of claim 12, wherein the multimedia data comprises at least one multimedia stream that includes an identifier of a source client device of the multimedia stream.

18. A system, comprising:
a memory subsystem storing instructions; and
processing circuitry configured to execute the instructions to:
receive, by a conferencing server and from a client device, a request to connect an ingestion server to a conference to which the client device is connected, the request comprising a token for authentication of the ingestion server and an identifier of the ingestion server;
establish, by the conferencing server and based on the token, a communication connection with the ingestion server; and
transmit, by the conferencing server and to the ingestion server, at least a portion of multimedia data of the conference using the communication connection based on the token.

19. The system of claim 18, the processing circuitry further configured to execute the instructions to:
establish multiple communication connections with multiple ingestion servers, including the ingestion server; and
simultaneously communicate, by the conferencing server, with the multiple ingestion servers.

20. The system of claim 18, the processing circuitry further configured to execute the instructions to:
grant, to the ingestion server, access permissions to the conference based, at least, on access permissions to the conference granted to the client device.
